(19) United States
(12) Patent Application Publication
(10) Pub. No.: US 2025/0375844 A1
(43) Pub. Date: Dec. 11, 2025

(54) MOVING PLATFORM

(71) Applicant: DELTA ELECTRONICS, INC., Taoyuan City (TW)

(72) Inventors: Chi-Huan SHAO, Taoyuan City (TW); Cheng-Hao HUANG, Taoyuan City (TW)

(21) Appl. No.: 18/797,505

(22) Filed: Aug. 8, 2024

(30) Foreign Application Priority Data
Jun. 6, 2024 (CN) 202410729011.7

(51) Int. Cl. B23Q 1/01; B23Q 1/62

(52) U.S. Cl. CPC B23Q 1/015; B23Q 1/621

(57) ABSTRACT

A moving platform includes two sliding seats, two sliding blocks, a carrying member, and two weight blocks. The two sliding seats extend along a first axis and are arranged in a second axis. The two sliding blocks are respectively slidably disposed at two inner sides of the two sliding seats to move along the first axis. The carrying member is connected between the two sliding blocks. The two weight blocks are slidably disposed at two outer sides of the two sliding seats to move along the first axis. The two sliding blocks and the two weight blocks are configured to move in opposite directions along the first axis.

This application claims priority to China Application Serial Number 202410729011.7, filed June 06, 2024, which is herein incorporated by reference.

### BACKGROUND

### TECHNICAL FIELD

The present disclosure relates to a moving platform.

### DESCRIPTION OF RELATED ART

In the current structure of the gantry-type moving platform, when the X-axis moves forward and backward and accelerates and decelerates, an impulse is generated on the moving platform. This energy must be offset on the structure of the moving platform, and this is the source of vibration kinetic energy. When the motion speed of the system is higher, its acceleration and deceleration will be higher, and the impact on the moving platform will be higher.

There are currently two ways to solve the aforementioned problems. The first way is to use damping design in the moving platform architecture. The second way is to enhance the structural rigidity and overall weight of the moving platform. However, these ways have upper limits on their stabilizing effects. In other words, the upper limit of system stability of the moving platform cannot be effectively improved.

Accordingly, how to provide a moving platform to solve the aforementioned problems becomes an important issue to be solved by those in the industry.

### SUMMARY

An aspect of the disclosure is to provide a moving platform that can efficiently solve the aforementioned problems.

According to an embodiment of the disclosure, a moving platform includes two sliding seats, two sliding blocks, a carrying member, two weight blocks, a first motion module, and a second motion module. The two sliding seats extend along a first direction and a second direction. The two sliding seats are arranged oppositely. The first direction and the second direction are opposite directions. The two sliding blocks are respectively disposed at inner sides of the two sliding seats to move along the first direction or the second direction. The carrying member extends in a third direction and a fourth direction to connect the two sliding blocks. The third direction and the fourth direction are opposite directions. The two weight blocks are respectively disposed at outer sides of the two sliding seats to move along the first direction or the second direction. The first motion module is connected to one of the two sliding blocks. The second motion module is connected to one of the two weight blocks. The one of the two sliding blocks and the one of the two weight blocks are located on one of the two sliding seats. The two sliding blocks and the two weight blocks are configured to move in opposite directions in the first direction and the second direction.

According to an embodiment of the disclosure, the moving platform further includes a first processing module and a second processing module. The first processing module is configured to control the first motion module to drive the one of the two sliding blocks to move along the first direction. The second processing module is configured to: calculate a driving force of the first motion module on the one of the two sliding blocks; and control the second motion module to drive the one of the two weight blocks to move along the second direction according to the driving force.

According to an embodiment of the disclosure, the moving platform further includes an accelerometer. The accelerometer is configured to detect an acceleration of the one of the two sliding blocks. The second processing module is configured to calculate the driving force based on the acceleration.

According to an embodiment of the disclosure, the second processing module includes a force estimator. The force estimator is configured to calculate the driving force based on the acceleration.

According to an embodiment of the disclosure, the first motion module includes an encoder. The encoder is configured to calculate an acceleration of the one of the two sliding blocks. The second processing module is configured to calculate the driving force based on the acceleration.

According to an embodiment of the disclosure, the second processing module includes a force estimator. The force estimator is configured to calculate the driving force based on the acceleration.

According to an embodiment of the disclosure, the second processing module is configured to control the second motion module to move the one of the two weight blocks with another driving force. A magnitude of the driving force is substantially equal to a magnitude of the another driving force.

According to an embodiment of the disclosure, the moving platform further includes a first slide rail set and a second slide rail set. The first slide rail set is disposed at the inner side of one of the two sliding seats. One of the two sliding blocks is slidably connected to the first slide rail set. The second slide rail set disposed at the outer side of the one of the two sliding seats. One of the two weight blocks is slidably connected to the second slide rail set.

According to an embodiment of the disclosure, the first slide rail set includes a first lower rail and a first upper rail. The second slide rail set includes a second lower rail and a second upper rail. The one of the two sliding seats includes a base portion and a wall portion. The base portion has a surface. The first lower rail and the second lower rail are disposed on the surface. The wall portion is connected to the surface and located between the first lower rail and the second lower rail. The first upper rail and the second upper rail are disposed at opposite sides of the wall portion.

According to an embodiment of the disclosure, a moving platform includes a sliding seat, a sliding block, a first motion module, a carrying member, a weight block, and a second motion module. The sliding seat extends along a first direction and a second direction and has a first side and a second side opposite to each other. The first direction and the second direction are opposite directions. The sliding block is disposed at the first side to move along the first direction or the second direction. The first motion module is connected to the sliding block. The carrying member is connected to the sliding block. The weight block is disposed at the second side to move along the first direction or the second direction. The second motion module is connected to the weight block. The sliding block and the weight block are configured to move in opposite directions in the first direction and the second direction.

According to an embodiment of the disclosure, the moving platform further includes a first processing module and a second processing module. The first processing module is configured to control the first motion module to drive the sliding block to move along the first direction. The second processing module is configured to: calculate a driving force of the first motion module on the sliding block; and control the second motion module to drive the weight block to move along the second direction according to the driving force.

According to an embodiment of the disclosure, the second processing module is configured to control the second motion module to move the weight block with another driving force. A magnitude of the driving force is substantially equal to a magnitude of the another driving force.

According to an embodiment of the disclosure, the moving platform further includes an accelerometer. The accelerometer is configured to detect an acceleration of the sliding block. The second processing module is configured to calculate the driving force based on the acceleration.

According to an embodiment of the disclosure, the first motion module includes an encoder configured to calculate an acceleration of the sliding block. The second processing module is configured to calculate the driving force based on the acceleration.

According to an embodiment of the disclosure, the moving platform further includes a first slide rail set and a second slide rail set. The first slide rail set is disposed at the first side of the sliding seat. The sliding block is slidably connected to the first slide rail set. The second slide rail set is disposed at the second side of the sliding seat. The weight block is slidably connected to the second slide rail set.

According to an embodiment of the disclosure, the first slide rail set includes a first lower rail and a first upper rail. The second slide rail set includes a second lower rail and a second upper rail. The two sliding seat includes a base portion and a wall portion. The base portion has a surface. The first lower rail and the second lower rail are disposed on the surface. The wall portion is connected to the surface and located between the first lower rail and the second lower rail. The first upper rail and the second upper rail are respectively disposed at opposite sides of the wall portion.

To sum up, in the moving platform of the present disclosure, when the sliding block disposed at one side of the slide seat moves along the sliding seat, the weight block disposed at another side of the sliding seat will move in the opposite direction along the sliding seat at the same time, thereby eliminating the vibration generated when the sliding block moves along the sliding seat. In other words, for the force exerted on the sliding seat when the sliding block moves, the moving platform of the present disclosure uses the force generated by the weight block on the sliding seat when the weight block moves in reverse direction to offset it. Moreover, the aforementioned vibration-absorbing mechanism can also reduce the change in the overall center of gravity of the moving platform when it operates. Therefore, the moving platform of the present disclosure can effectively increase the ultimate speed of movement.

The above is only used to describe the problems to be solved by the present disclosure, technical solutions to solve the problems and their effects, and so on. Specific details of the present disclosure will be described in the following embodiments with reference to relevant drawings.

### BRIEF DESCRIPTION OF THE DRAWINGS

In order to make the above and other purposes, features, advantages, and embodiments of the present disclosure easier to understand, the accompanying drawings are provided and described as follows.

FIG. 1 is a perspective view of a moving platform according to an embodiment of the present disclosure;

FIG. 2A is a top view of the moving platform in FIG. 1;

FIG. 2B is another top view of the moving platform in FIG. 1;

FIG. 3 is a partial perspective cross-sectional view of the moving platform in FIG. 2A taken along line 3-3;

FIG. 4 is a functional block diagram of some components of the moving platform according to an embodiment of the present disclosure; and

FIG. 5 is a functional block diagram of some components of a moving platform according to another embodiment of the present disclosure.

### DETAILED DESCRIPTION

A plurality of embodiments of the present disclosure will be described below with reference to the accompanying drawings. For the sake of clarity, many practical details will be described together in the following description. However, it should be understood that these practical details should not be used to limit the present disclosure. That is to say, in some embodiments of the present disclosure, these practical details are not necessary. In addition, for the sake of simplifying the accompanying drawings, some commonly used structures and components are illustrated in the accompanying drawings in a simple schematic manner.

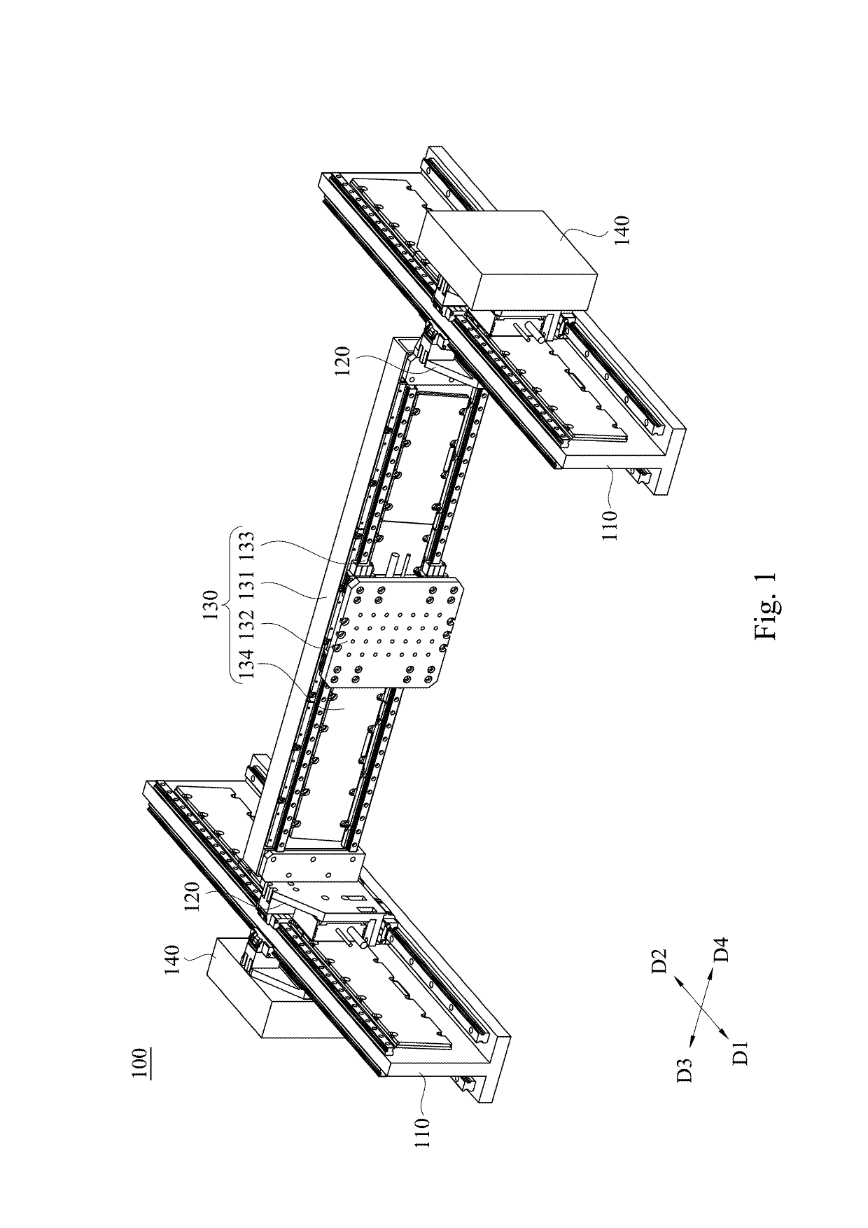

Reference is made to FIG. 1. FIG. 1 is a perspective view of a moving platform 100 according to an embodiment of the present disclosure. As shown in FIG. 1, the moving platform 100 includes two sliding seats 110, two sliding blocks 120, a carrying member 130, and two weight blocks 140. The two sliding seats 110 extend along a first direction D1 and a second direction D2, and the two sliding seats 110 are arranged oppositely. The first direction D1 and the second direction D2 are opposite directions. The two sliding blocks 120 are respectively disposed at inner sides of the two sliding seats 110 (that is, the sides of the two sliding seats 110 facing each other) to move along the first direction D1 or the second direction D2. The carrying member 130 extends in a third direction D3 and a fourth direction D4 to be connected between the two sliding blocks 120. The third direction D3 and the fourth direction D4 are opposite directions. In this way, when the two sliding blocks 120 move along the first direction D1 or the second direction D2, the carrying member 130 can be driven to move along the first direction D1 or the second direction D2. The two weight blocks 140 are respectively disposed at outer sides of the two sliding seats 110 (that is, the sides of the two sliding seats 110 facing away from each other) to move along the first direction D1 or the second direction D2. The two sliding blocks 120 and the two weight blocks 140 are configured to move in opposite directions in the first direction D1 and the second direction D2.

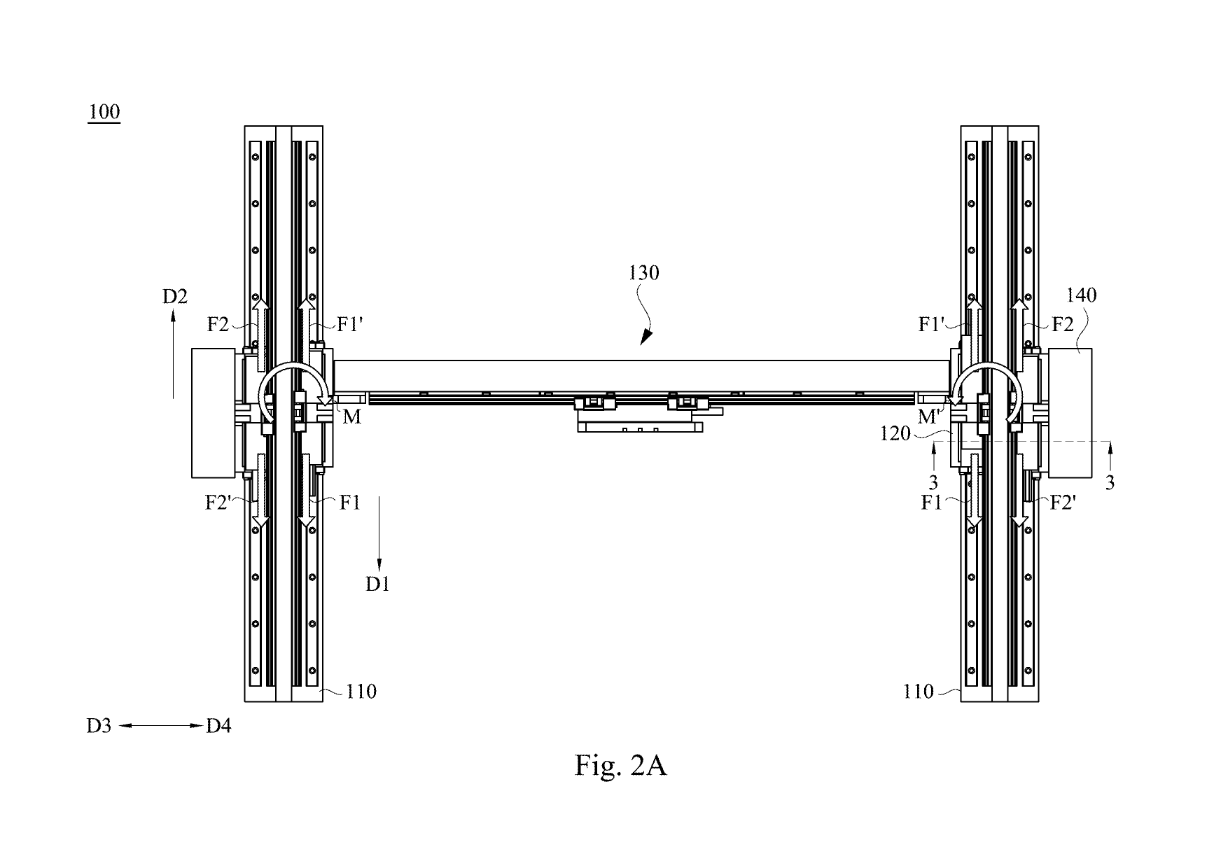

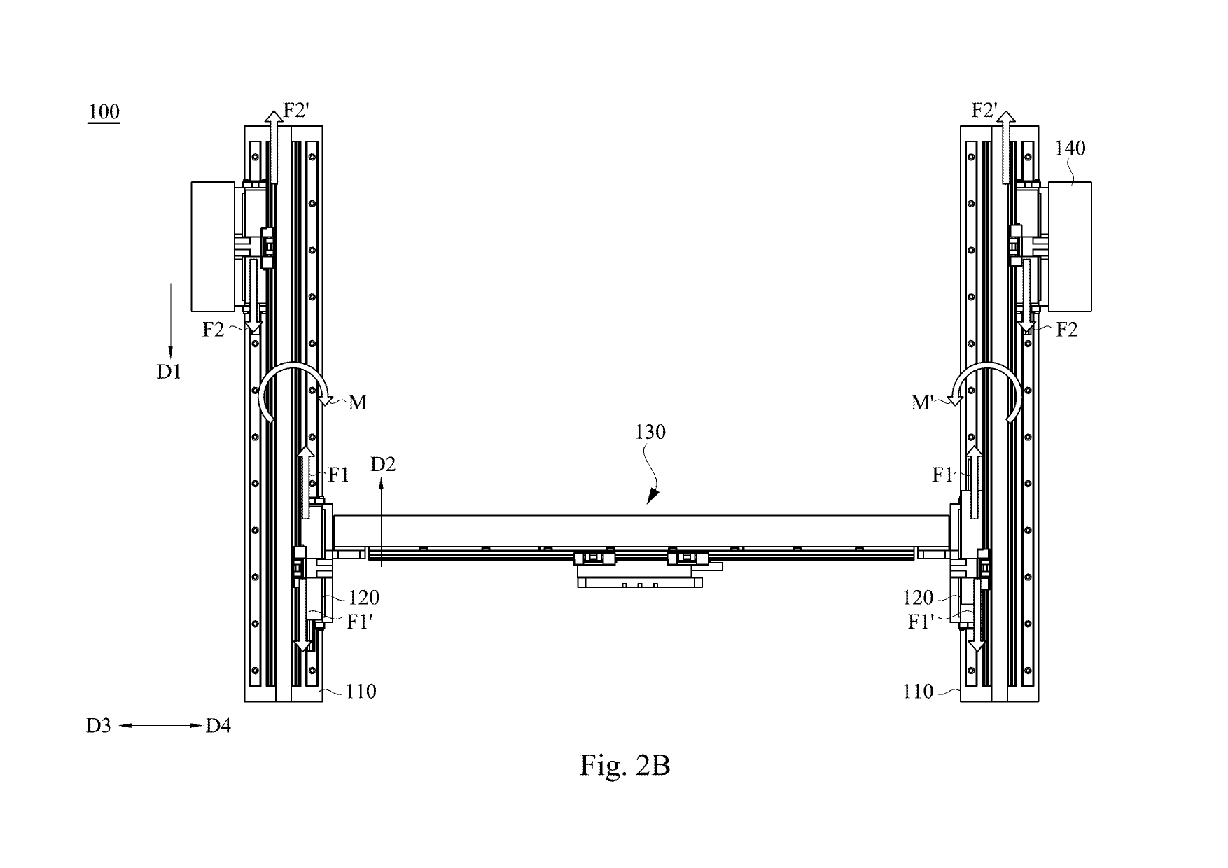

Reference is made to FIG. 2A and FIG. 2B. FIG. 2A is a top view of the moving platform 100 in FIG. 1. FIG. 2B is another top view of the moving platform 100 in FIG. 1. As shown in FIG. 2A and FIG. 2B, the two sliding blocks 120 and the two weight blocks 140 are configured to move in opposite directions in the first direction D1 and the second direction D2. For example, when the two sliding blocks 120 move along the first direction D1 (that is, the two sliding blocks 120 move from the positions in FIG. 2A to the positions in FIG. 2B), the two weight blocks 140 simultaneously move along the second direction D2. On the contrary, when the two sliding blocks 120 move along the second direction D2 (that is, the two sliding blocks 120 move from the positions in FIG. 2B to the positions in FIG. 2A), the two weight blocks 140 simultaneously move along the first direction D1.

In detail, as shown in FIG. 2A, when the moving platform 100 applies a driving force F1 to each of the sliding blocks 120 along the first direction D1 to move the sliding blocks 120 relative to the sliding seats 110 along the first direction D1, a reaction force F1’ along the second direction D2 and equal to the driving force F1 will be generated on each of the sliding seats 110. At the same time, the moving platform 100 applies a driving force F2 to each of the weight block 140 along the second direction D2 to move the weight blocks 140 relative to the sliding seats 110 along the second direction D2, and a reaction force F2’ along the first direction D1 and equal to the driving force F2 will be generated on each of the sliding seats 110. On the contrary, as shown in FIG. 2B, when the moving platform 100 applies the driving force F1 to each of the sliding blocks 120 along the second direction D2 to move the sliding blocks 120 relative to the sliding seats 110 along the second direction D2, the reaction force F1’ along the first direction D1 and equal to the driving force F1 will be generated on each of the sliding seats 110. At the same time, the moving platform 100 applies the driving force F2 to each of the weight block 140 along the first direction D1 to move the weight blocks 140 relative to the sliding seats 110 along the first direction D1, and a reaction force F2’ along the second direction D2 and equal to the driving force F2 will be generated on each of the sliding seats 110. By making a magnitude of the driving force F1 substantially equal to a magnitude of the driving force F2, magnitudes of the corresponding reaction forces F1' and F2' generated on each of the sliding seats 110 can be made substantially equal, thereby offsetting the impact of the driving force F1 on the moving platform 100.

Through the aforementioned structural configurations, the moving platform 100 of the present embodiment can use the two weight blocks 140 to eliminate the vibration generated when the sliding blocks 120 moves along the sliding seats 110. In other words, for the reaction forces F1’ respectively exerted on the two sliding seats 110 when the two sliding blocks 120 move, the moving platform 100 of the present embodiment uses the reaction forces F2’ respectively generated by the weight blocks 140 on the two sliding seats 110 when the two weight blocks 140 move in reverse direction to offset. Moreover, the aforementioned vibration-absorbing mechanism can also reduce the change in the overall center of gravity of the moving platform 100 when it operates. Therefore, the moving platform 100 of the present embodiment can effectively increase the ultimate speed of movement.

In addition, as shown in FIG. 2A and FIG. 2B, the reaction forces F1’ and F2’ generated on the left sliding seat 110 will generate a torque M, the reaction forces F1’ and F2’ generated on the right sliding seat 110 will generate a torque M’, and the torques M and M’ are the same in magnitude and opposite in direction. It should be noted that the torques M and M’ are not the key factors affecting the vibration of the moving platform 100, and can be resisted by utilizing the overall structural rigidity of the moving platform 100.

In some embodiments, a combination of one set of the sliding seat 110, the sliding block 120, and the weight block 140 can be cancelled. That is, only one end of the carrying member 130 is connected to the sliding block 120, and the other end thereof is suspended. The aforementioned vibration-absorbing mechanism can still be implemented in a moving platform 100 that only has a combination of one set of the sliding seat 110, the sliding block 120, and the weight block 140.

As shown in FIG. 1, in the present embodiment, the carrying member 130 includes a sliding seat 131, a sliding block 132, a rail 133, and a motion module 134. The sliding seat 131 is connected between the two sliding blocks 120. The rail 133 is disposed on the sliding seat 131 and extends along the third direction D3 and the fourth direction D4. The sliding block 132 is slidably engaged with the rail 133 to move along the third direction D3 or the fourth direction D4. The motion module 134 is disposed on the sliding seat 131 and configured to move the sliding block 132. In this way, the moving platform 100 of the present embodiment can be used as an XY table. For example, the moving platform 100 may be a gantry-type sliding platform, but the present disclosure is not limited thereto.

In some embodiments, the motion module 134 is a linear motor, but the present disclosure is not limited thereto.

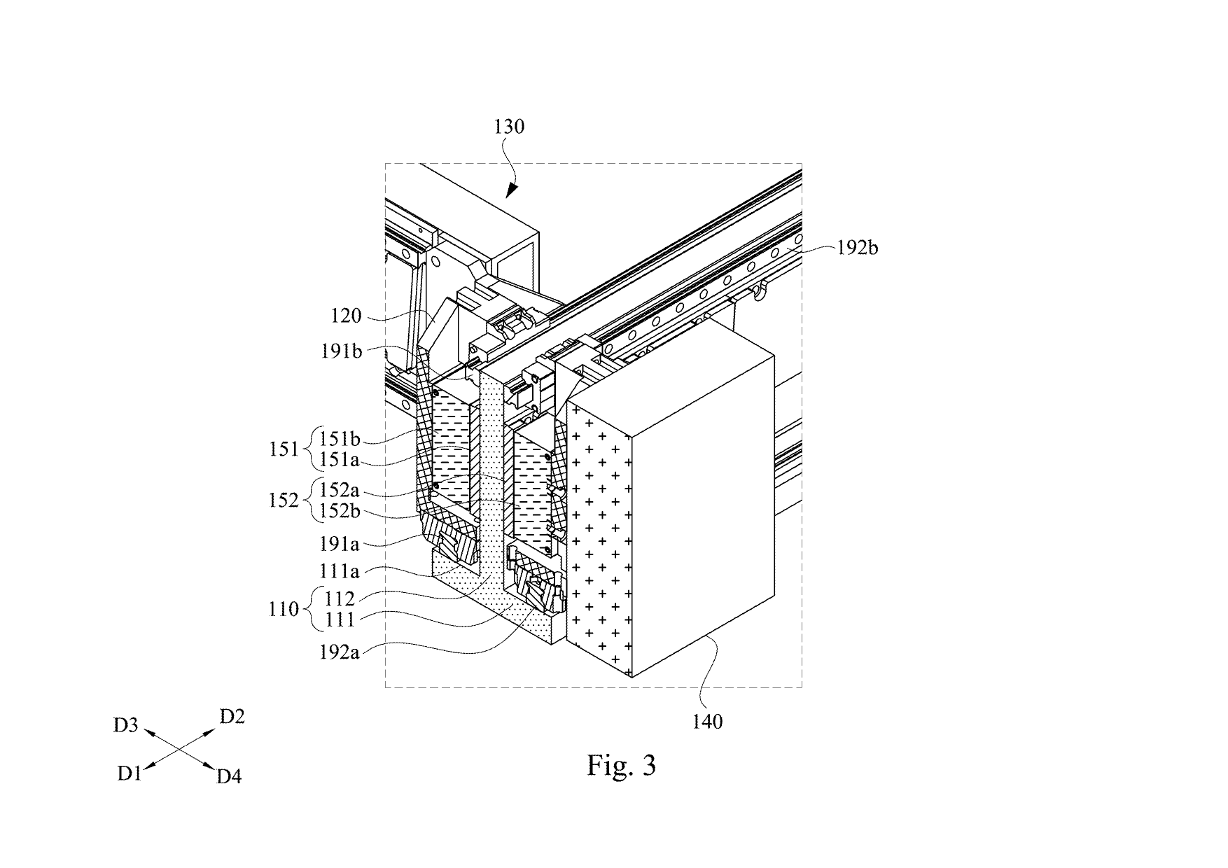

Reference is made to FIG. 3. FIG. 3 is a partial perspective cross-sectional view of the moving platform 100 in FIG. 2A taken along line 3-3. As shown in FIG. 3, the moving platform 100 further includes a first motion module 151 and a second motion module 152. The first motion module 151 and the second motion module 152 are linear motors. Specifically, the first motion module 151 is disposed at the inner side of the sliding seat 110 and includes a stator 151a and a mover 151b. The stator 151a is fixed to the sliding seat 110, and the mover 151b is fixed to the sliding block 120. When the first motion module 151 operates, the driving force F1 will be generated and applied to the mover 151b (it can also be regarded as the first motion module 151 applying the driving force F1 to the sliding block 120), and the reaction force F1’ will be generated on the stator 151a at the same time. The second motion module 152 is disposed at the outer side of the sliding seat 110 and includes a stator 152a and a mover 152b. The stator 152a is fixed to the sliding seat 110, and the mover 152b is fixed to the weight block 140. When the second motion module 152 operates, the driving force F2 will be generated and applied to the mover 152b (it can also be regarded as the second motion module 152 applying the driving force F2 to the weight block 140), and the reaction force F2’ will be generated on the stator 152a at the same time.

As shown in FIG. 3, each of the sliding seats 110 of the moving platform 100 further includes a first slide rail set and a second slide rail set. The first slide rail set is disposed at the inner side of the sliding seat 110. The first slide rail set includes a first lower rail 191a and a first upper rail 191b. The first lower rail 191a and the first upper rail 191b extend along the first direction D1 and the second direction D2. The sliding block 120 is slidably engaged with the first slide rail set. The second slide rail set is disposed at the outer side of the sliding seat 110. The second slide rail set includes a second lower rail 192a and a second upper rail 192b. The second lower rail 192a and the second upper rail 192b extend along the first direction D1 and the second direction D2. The weight block 140 is slidably engaged with the second slide rail set. By making the sliding seat 110 be slidably connected to the sliding block 120 through the first slide rail set, the sliding block 120 can slide more smoothly on the inner side of the sliding seat 110. Similarly, by making the sliding seat 110 be slidably connected to the weight block 140 through the second slide rail set, the weight block 140 can slide more smoothly on the outer side of the sliding seat 110.

Furthermore, as shown in FIG. 3, the sliding seat 110 includes a base portion 111 and a wall portion 112. The base portion 111 has a surface 111a. The first lower rail 191a and the second lower rail 192a are disposed on the surface 111a. The wall portion 112 is connected to the surface 111a of the base portion 111 and located between the first lower rail 191a and the second lower rail 192a. The first upper rail 191b and the second upper rail 192b are disposed at opposite sides of the wall portion 112. The first lower rail 191a is configured to guide the sliding block 120 to move along the first direction D1 or the second direction D2 and mainly bear the weight of the sliding block 120, and the first upper rail 191b is configured to auxiliarily guide the sliding block 120 to move along the first direction D1 or the second direction D2. The second lower rail 192a is configured to guide the weight block 140 to move along the first direction D1 or the second direction D2 and mainly bear the weight of the weight block 140, and the second upper rail 192b is configured to auxiliarily guide the weight block 140 to move along the first direction D1 or the second direction D2.

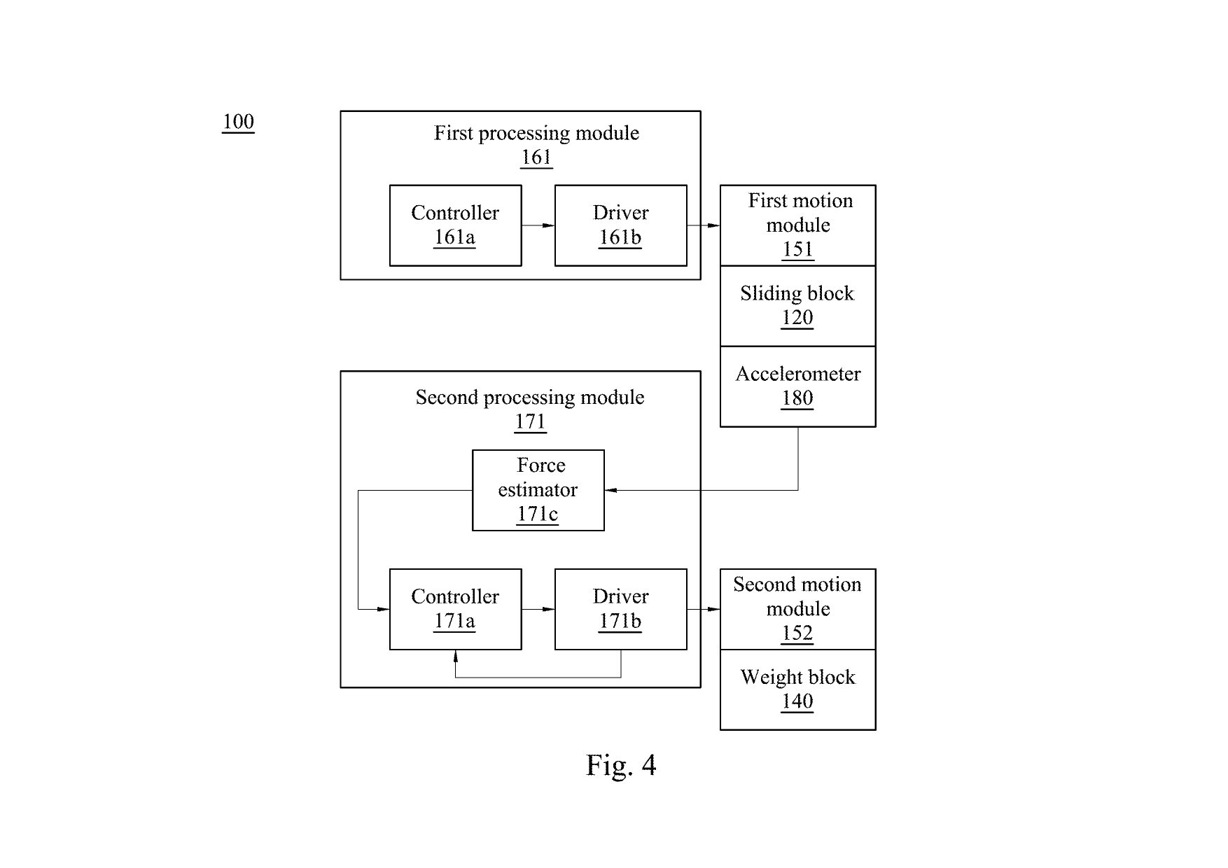

Reference is made to FIG. 4. FIG. 4 is a functional block diagram of some components of the moving platform 100 according to an embodiment of the present disclosure. As shown in FIG. 4, the moving platform 100 further includes a first processing module 161 and a second processing module 171. The first processing module 161 is configured to control the first motion module 151 to drive the sliding block 120 to move along the first direction D1 or the second direction D2. The second processing module 171 is configured to calculate a driving force of the first motion module 151 on the sliding block 120, and control the second motion module 152 to drive the weight block 140 to move along the first direction D1 or the second direction D2 according to the driving force.

Specifically, the first processing module 161 includes a controller 161a and a driver 161b. The controller 161a is configured to control the driver 161b according to the position information of the sliding block 120 in the first direction D1 or the second direction D2, so that the driver 161b controls the first motion module 151 to move the sliding block 120 with the driving force F1 (see FIG. 2A together). The moving platform 100 further includes an accelerometer 180. The accelerometer 180 is configured to detect an acceleration of the sliding block 120. The second processing module 171 is configured to calculate the driving force F1 generated by the first motion module 151 based on the acceleration. In addition, the second processing module 171 includes a controller 171a, a driver 171b, and a force estimator 171c. The force estimator 171c is connected to the accelerometer 180 and configured to calculate the driving force F1 based on the acceleration. The controller 171a is configured to control the driver 171b, so that the driver 171b controls the second motion module 152 to move the weight block 140 with the driving force F2 (see FIG. 2A together). In some embodiments, the controller 171a of the second processing module 171 is configured to control the driver 171b according to the position information of the sliding block 120 in the first direction D1 or the second direction D2, the driving force F1 obtained by the force estimator 171c, and the driving force F2 (i.e., feedback) obtained by the driver 171b.

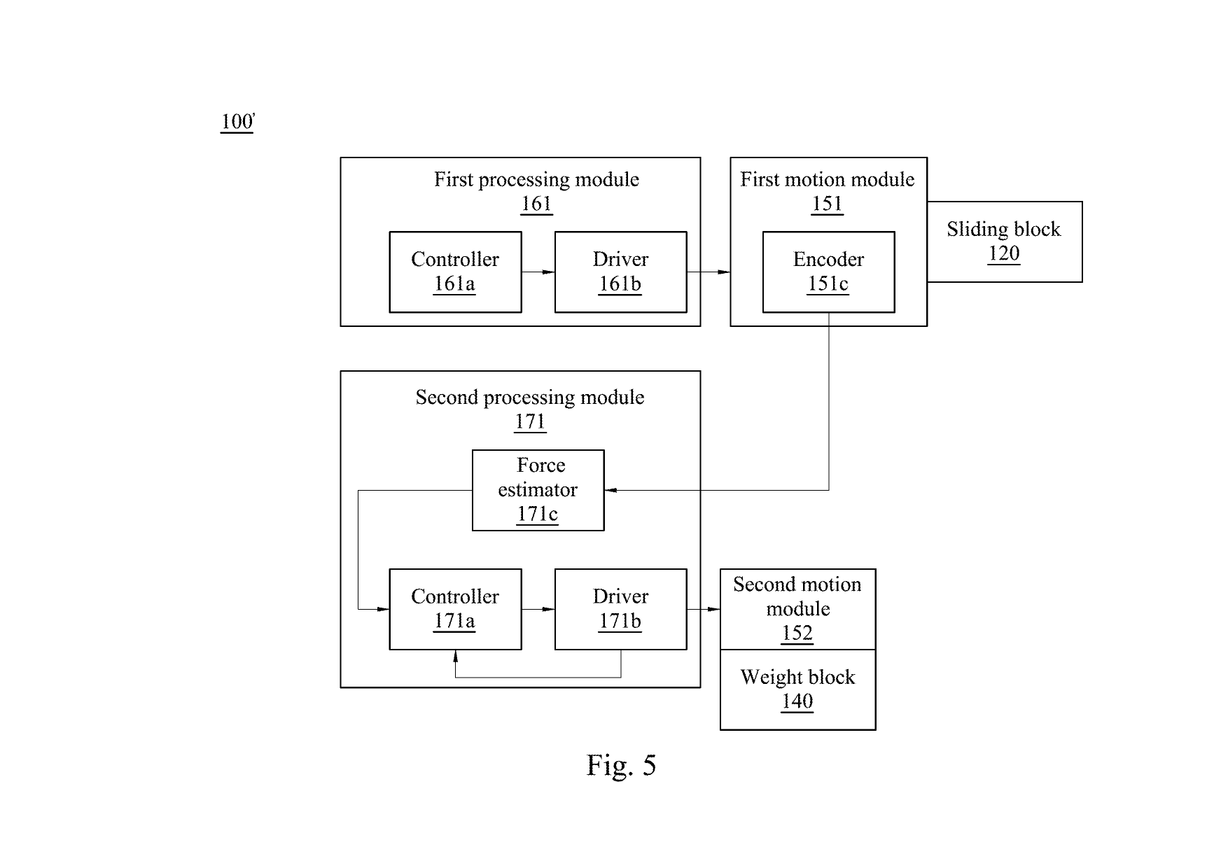

Reference is made to FIG. 5. FIG. 5 is a functional block diagram of some components of a moving platform 100’ according to another embodiment of the present disclosure. As shown in FIG. 5, the moving platform 100’ also includes the first processing module 161, the first motion module 151, the second processing module 171, and the second motion module 152. Compared with the moving platform 100 shown in FIG. 4, the moving platform 100’ of the present embodiment omits the accelerometer 180. In addition, in the present embodiment, the first motion module 151 further includes an encoder 151c. The encoder 151c is configured to calculate the acceleration of the sliding block 120. The force estimator 171c is connected to the encoder 151c and configured to calculate the driving force F1 based on the acceleration.

According to the foregoing recitations of the embodiments of the disclosure, it can be seen that in the moving platform of the present disclosure, when the sliding block disposed at one side of the slide seat moves along the sliding seat, the weight block disposed at another side of the sliding seat will move in the opposite direction along the sliding seat at the same time, thereby eliminating the vibration generated when the sliding block moves along the sliding seat. In other words, for the force exerted on the sliding seat when the sliding block moves, the moving platform of the present disclosure uses the force generated by the weight block on the sliding seat when the weight block moves in reverse direction to offset it. Moreover, the aforementioned vibration-absorbing mechanism can also reduce the change in the overall center of gravity of the moving platform when it operates. Therefore, the moving platform of the present disclosure can effectively increase the ultimate speed of movement.

Although the present disclosure is disclosed in the above embodiments, the embodiments are not intended to limit the present disclosure. Anyone skilled in the art can make various changes and modifications without departing from the spirit and scope of the present disclosure. Therefore, the protection scope of the present disclosure shall be determined by the appended claims.

What is claimed is:

1. A moving platform, comprising:
two sliding seats extending along a first direction and a second direction, the two sliding seats being arranged oppositely, wherein the first direction and the second direction are opposite directions;
two sliding blocks respectively disposed at inner sides of the two sliding seats to move along the first direction or the second direction;
a carrying member extending in a third direction and a fourth direction to connect the two sliding blocks, wherein the third direction and the fourth direction are opposite directions;
two weight blocks respectively disposed at outer sides of the two sliding seats to move along the first direction or the second direction;
a first motion module connected to one of the two sliding blocks; and
a second motion module connected to one of the two weight blocks, wherein the one of the two sliding blocks and the one of the two weight blocks are located on one of the two sliding seats,
wherein the two sliding blocks and the two weight blocks are configured to move in opposite directions in the first direction and the second direction.

2. The moving platform of claim 1, further comprising:
a first processing module configured to control the first motion module to drive the one of the two sliding blocks to move along the first direction; and
a second processing module configured to:
calculate a driving force of the first motion module on the one of the two sliding blocks; and
control the second motion module to drive the one of the two weight blocks to move along the second direction according to the driving force.

3. The moving platform of claim 2, further comprising an accelerometer configured to detect an acceleration of the one of the two sliding blocks, wherein the second processing module is configured to calculate the driving force based on the acceleration.

4. The moving platform of claim 3, wherein the second processing module comprises a force estimator, and the force estimator is configured to calculate the driving force based on the acceleration.

5. The moving platform of claim 2, wherein the first motion module comprises an encoder configured to calculate an acceleration of the one of the two sliding blocks, and the second processing module is configured to calculate the driving force based on the acceleration.

6. The moving platform of claim 5, wherein the second processing module comprises a force estimator, and the force estimator is configured to calculate the driving force based on the acceleration.

7. The moving platform of claim 2, wherein the second processing module is configured to control the second motion module to move the one of the two weight blocks with another driving force, and a magnitude of the driving force is substantially equal to a magnitude of the another driving force.

8. The moving platform of claim 2, further comprising:
a first slide rail set disposed at the inner side of one of the two sliding seats, wherein one of the two sliding blocks is slidably connected to the first slide rail set; and
a second slide rail set disposed at the outer side of the one of the two sliding seats, wherein one of the two weight blocks is slidably connected to the second slide rail set.

9. The moving platform of claim 8, wherein the first slide rail set comprises a first lower rail and a first upper rail, the second slide rail set comprises a second lower rail and a second upper rail, and the one of the two sliding seats comprises:
a base portion having a surface, wherein the first lower rail and the second lower rail are disposed on the surface; and
a wall portion connected to the surface and located between the first lower rail and the second lower rail, wherein the first upper rail and the second upper rail are respectively disposed at opposite sides of the wall portion.

10. A moving platform, comprising:
a sliding seat extending along a first direction and a second direction and having a first side and a second side opposite to each other, wherein the first direction and the second direction are opposite directions;
a sliding block disposed at the first side to move along the first direction or the second direction;
a first motion module connected to the sliding block;
a carrying member connected to the sliding block;
a weight block disposed at the second side to move along the first direction or the second direction; and
a second motion module connected to the weight block,
wherein the sliding block and the weight block are configured to move in opposite directions in the first direction and the second direction.

11. The moving platform of claim 10, further comprising:
a first processing module configured to control the first motion module to drive the sliding block to move along the first direction; and
a second processing module configured to:
calculate a driving force of the first motion module on the sliding block; and
control the second motion module to drive the weight block to move along the second direction according to the driving force.

12. The moving platform of claim 11, wherein the second processing module is configured to control the second motion module to move the weight block with another driving force, and a magnitude of the driving force is substantially equal to a magnitude of the another driving force.

13. The moving platform of claim 11, further comprising an accelerometer configured to detect an acceleration of the sliding block, wherein the second processing module is configured to calculate the driving force based on the acceleration.

14. The moving platform of claim 11, wherein the first motion module comprises an encoder configured to calculate an acceleration of the sliding block, and the second processing module is configured to calculate the driving force based on the acceleration.

15. The moving platform of claim 11, further comprising:
a first slide rail set disposed at the first side of the sliding seat, wherein the sliding block is slidably connected to the first slide rail set; and
a second slide rail set disposed at the second side of the sliding seat, wherein the weight block is slidably connected to the second slide rail set.

16. The moving platform of claim 15, wherein the first slide rail set comprises a first lower rail and a first upper rail, the second slide rail set comprises a second lower rail and a second upper rail, and the sliding seat comprises:
a base portion having a surface, wherein the first lower rail and the second lower rail are disposed on the surface; and
a wall portion connected to the surface and located between the first lower rail and the second lower rail, wherein the first upper rail and the second upper rail are respectively disposed at opposite sides of the wall portion.
